(19) United States
(12) Patent Application Publication
(10) Pub. No.: US 2015/0316737 A1
(43) Pub. Date: Nov. 5, 2015

(54) CASSETTE LATCHING ASSEMBLY WITH MULTIPLE INDEPENDENT LATCHES

(71) Applicant: CORNING OPTICAL COMMUNICATIONS LLC, HICKORY, NC (US)

(72) Inventors: William Julius McPhil Giraud, Azle, TX (US); Diana Rodriguez, Fort Worth, TX (US)

(21) Appl. No.: 14/704,357

(22) Filed: May 5, 2015

Related U.S. Application Data
(60) Provisional application No. 61/988,623, filed on May 5, 2014.

(51) Int. Cl. G02B 6/44; F16B 2/22

(52) U.S. Cl. CPC G02B 6/4452; F16B 2/22; G02B 6/4453

(57) ABSTRACT

A latching assembly having a frame and a plurality of latches pivotably attached to the frame, and an attachment feature is disclosed. The attachment feature adapted to toollessly and removably attach the frame of the latching assembly to at least one of a housing and a chassis. Each of the plurality of latches may be independently actuatable to pivot the latch to allow individual cassettes in the chassis to move in the chassis.

### PRIORITY APPLICATION

This application claims the benefit of priority under 35 U.S.C. §119 of U.S. Provisional Application Ser. No. 61/988,623 filed on May 5, 2014, the content of which is relied upon and incorporated herein by reference in its entirety.

### BACKGROUND

1. Field of the Disclosure

The disclosure relates generally to optical cable apparatus more particularly to a cassette latching assembly having multiple independent latches for latching individual cassettes in a housing or chassis.

2. Technical Background

In optical cable networking apparatus including convergence points and distribution frames, such as in fiber-optics networking, there is an increasing demand for components that facilitate high-density distribution with very high fiber termination counts in a small, confined volume. The distribution frames may be located in central offices while the convergence points may be outdoor cabinets located throughout the network. Accomplishing the high-density distribution with high fiber termination counts requires efficient utilization of space with due regard to constraints put on optical cables, such as minimum bending radius. As such, an ongoing need exists for optical-cable networking components that can effectively utilize a confined volume when large numbers of optical cables are present, while simultaneously avoiding sharp bends to the optical cables.

### SUMMARY

Embodiments relate to a latching assembly. The latching assembly may have a frame, a plurality of latches pivotably attached to the frame, and an attachment feature. The attachment feature may be adapted to toollessly and removably attach the frame of the latching assembly to at least one of a housing and a chassis. Each of the plurality of latches may be independently actuatable to pivot and configured to allow individual cassettes in the chassis to move in the chassis.

Additional features and advantages will be set forth in the detailed description which follows, and in part should be readily apparent to those skilled in the art from the description or recognized by practicing the embodiments as described in the written description and claims hereof, as well as the appended drawings. It is to be understood that both the foregoing general description and the following detailed description describe various embodiments and are intended to provide an overview or framework for understanding the nature and character of the claimed subject matter.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a perspective outward side view of a latching assembly according to an exemplary embodiment;

FIG. 1B is a perspective inward side view of the latching assembly of FIG. 1A;

FIG. 2 is a perspective top view of a cassette;

FIG. 3 is a partial perspective top view of a chassis with the latching assembly of FIG. 1 attached but without any cassettes positioned therein;

FIG. 4 is a perspective top view of the chassis of FIG. 3 with cassettes positioned in the chassis;

FIG. 5 is a partial perspective top view of the chassis of FIG. 3 with cassettes positioned in the chassis in the closed position and with the latch detent in a closed position notch;

FIG. 6 is a partial perspective top view of the chassis of FIG. 3 with cassettes positioned in the chassis in the access position and with the latch detent in an access position notch;

FIG. 7A is a perspective outward side view of a latching assembly according to an exemplary embodiment; and

FIG. 7B is a perspective inward side view of the latching assembly of FIG. 7A.

### DETAILED DESCRIPTION

Embodiments of a latching assembly will now be described. The latching assembly may have a frame, a plurality of latches pivotably attached to the frame, and an attachment feature. The attachment feature may be adapted to toollessly and removably attach the frame of the latching assembly to at least one of a housing and a chassis. Each of the plurality of latches may be independently actuatable to pivot and configured to allow individual cassettes in the chassis to move in the chassis.

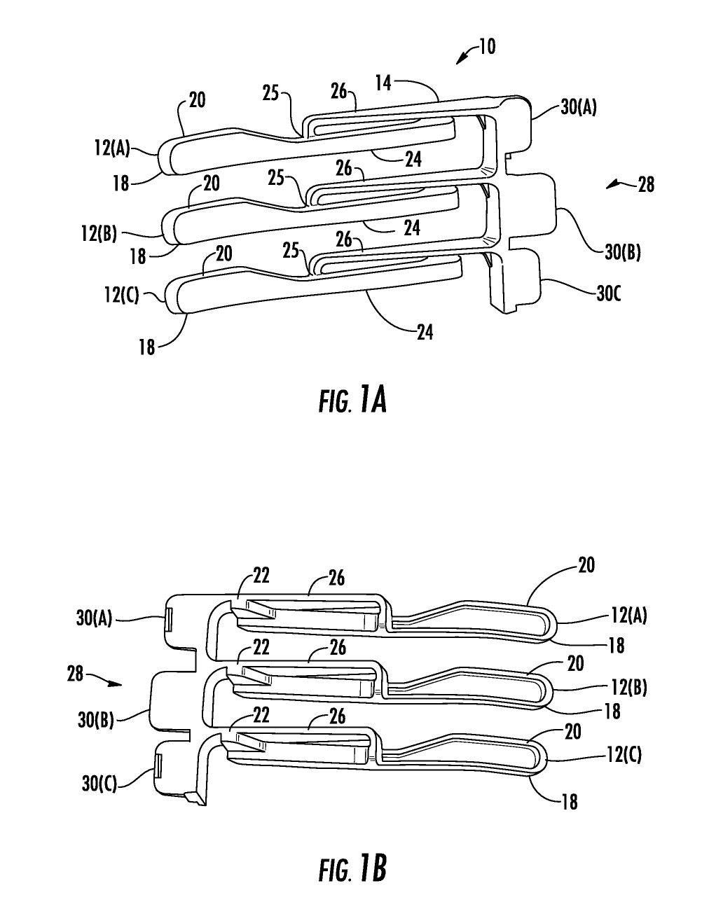

Referring to FIGS. 1A and 1B there are shown an outward side and an inward side, respectively, of latching assembly 10. Latching assembly 10 has multiple independently actuatable latches 12 pivotly attached to frame 14. Latch 12 and frame 14 may be monolithically constructed from one piece of material, including, as a non-limiting example, plastic. Alternatively, latch 12 and frame 14 may be not be monolithically made or may be constructed from different materials. In FIGS. 1A and 1B, three independently actuatable latches 12A, 12B and 12C are shown, but it should be understood that latching assembly 10 may have any number of independently actuatable latches 12. Latch 12 may have a first end and a second end 18 with finger actuator 20 at first end 16 and detent 22 at second end 18. Arm 24 may extend between first end and second end 18 and may have a pivot point 25 positioned along its length.

Latch 12 may pivotly attach to support member 26 of frame 14 using any suitable pivoting mechanism, such as, without limitation, a “living” pivot constructed of the same material as the latch 12 and frame 14. Alternatively, other pivoting mechanisms may be used. In FIGS. 1A and 1B a separate support member 26A, 26B, 26C pivotly attaches to each latch 12A, 12B, 12C, respectively. However, it should be understood that a latch 12 may not be pivotly attached to a separate support member 26, or a latch 12 may be attached to more than one support member 26. Attachment feature 28 extends from frame 14 and may be used to attach the latching assembly 10 to a housing or chassis (not shown in FIGS. 1A or 1B). In FIGS. 1A and 1B, attachment feature 28 is shown as three tabs 30A, 30B, 30C, but any suitable attachment feature 28 may be used. Attachment feature 28 may allow latching assembly to toollessly attach to housing or chassis. Latch 12 may be resiliently biased inwardly. Operating the finger actuator 20 by applying pressure on finger actuator 20 pivots latch 12 outwardly. When pressure is removed from finger actuator 20, latch 12 may pivot back inwardly due to its resiliently biased aspect. Additionally, each latches 12 may be independently actuated in this manner and may independently pivot from other latches 12 in the latch assembly 10.

Referring now to FIG. 2, there is illustrated a cassette 32 without a cover and having first side 34 and second side 36 with rails 38, 40 extending from sides 36, 38 respectively. One or more position notches may be formed in either or both rails 38, 40. Position notches may include closed position notch 42, access position notch 44 and remove position notch 46. Although FIG. 2 illustrates three position notches 42, 44, 46, any number of position notches may be used. Closed position notch 42 is shown with sides that angle outwardly while access position notch 44 and remove position notch 46 are shown with straight side. However, it should be understood that notches 42, 44, 46 are not limited to such construction.

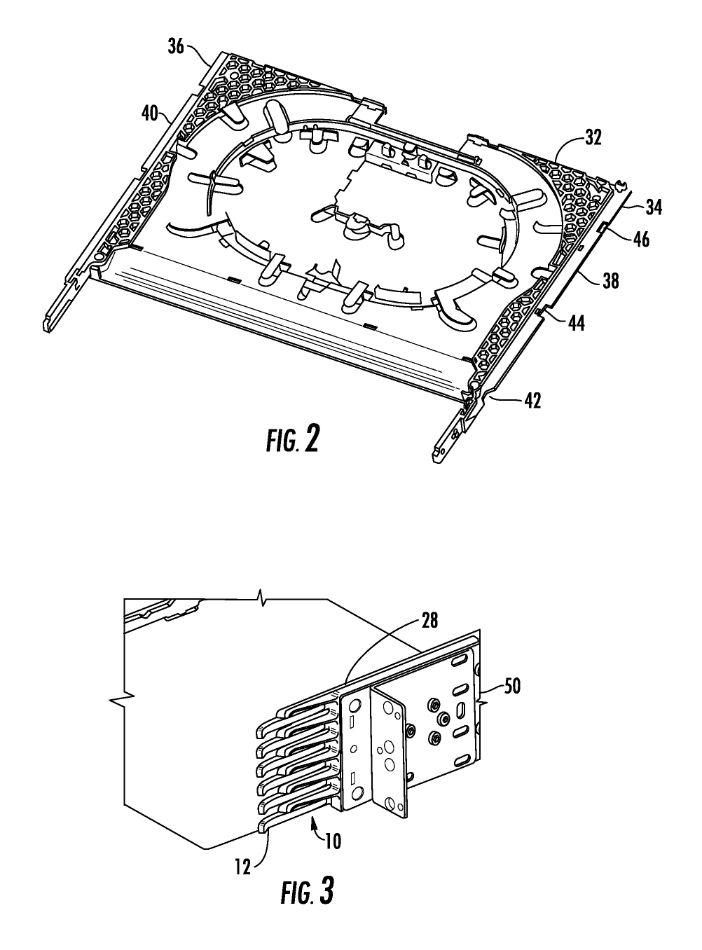

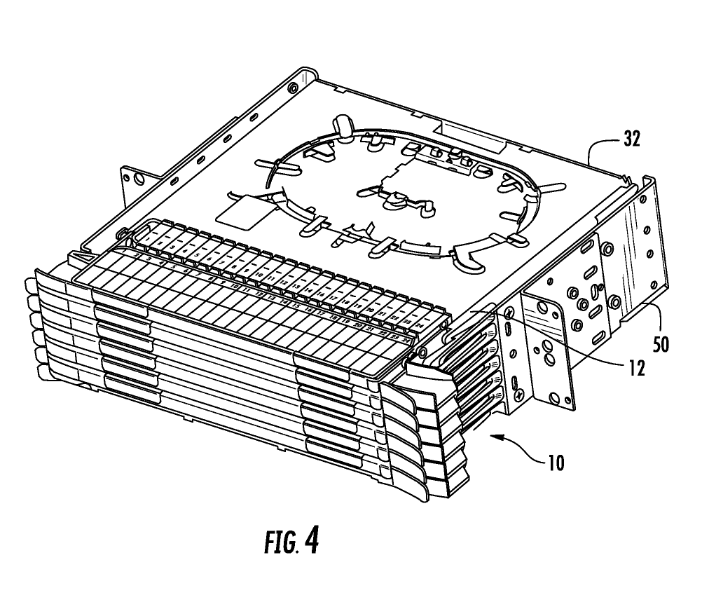

FIG. 3 shows latching assembly 10 removably and toollessly attached to chassis 50 without cassettes 32 installed in chassis 50. The latching assembly may attach to one or both sides 52 of chassis 50 via attachment feature 28. Attaching feature 28 may align with and attach to or insert into a receiving feature (not shown in FIG. 3) structured to provide a complementary interface with the attachment feature 28 to support and position latching assembly 10 such that latches 12 align with one of rails 38, 40 of cassette 32. FIG. 4 shows chassis 50 with cassettes 32 installed and latches 12 of latching assembly 10 aligned with individual cassettes 32.

Cassettes 32 may each include a tray base having a tray top surface. A tray center portion may be defined on the tray top surface inside a plurality of tray cable securing members arranged around a center-portion periphery of the tray center portion. The tray center portion may have a tray proximal zone and a tray distal zone defined thereon. The cassette 32 may further include a device holder removably and hingedly attached to the tray base and having a holder-closed position and a holder-open position. The device holder may include a holder inner surface and a holder outer surface opposite the holder inner surface.

The holder inner surface may have a holder proximal zone and a holder distal zone defined thereon. The device holder may include a plurality of holder cable securing members arranged around a holder periphery of the device holder. At least one device securing member may be disposed in the holder proximal zone and configured to secure an optical device to the holder inner surface. When the device holder is in the holder-closed position and an optical device is secured in the at least one device securing member of the device holder, the holder distal zone overlies the tray distal zone and the optical device overlies the tray proximal zone.

In some embodiments the cassette 32 may contain one or more additional features shown in the figures. For example, the cassette 32 may include an adapter bank that includes a plurality of adapters for connecting external devices (not shown) to optical cables within the cassette 32. As another example of an additional feature, the cassette 32 may include a drop handle having a cable guidance end. The drop handle may cover the adapter panel when the adapter panel is not in use or may protect connectors that are plugged into the adapter panel when the adapter panel is in use. The drop handle also may include a pivot or hinge that allows the drop handle to swing up and down to provide access to the adapter panel.

As another example of an additional feature, the cassette 32 may include a tray cover hingedly attached to the tray base on a side of the tray base by a cover hinge, for example. In such embodiments, the tray cover may be made of a transparent or translucent material that enables a technician to view connections and devices on the tray base through the tray cover.

FIG. 5 shows detent 22 of latch 12 located in closed position notch 42 of cassette 32. In this position the cassette 32 is fully inserted in chassis 50. Since the closed position notch 42 has angled sides, the cassette 32 may be extended from the chassis 32 without manually operating the finger actuator 20 to pivot the latch 12 and move detent 22 out of closed position notch 42. As the cassette 32 is extended from the chassis 50, the detent 22 moves along the angled side of closed position notch 42 until it is outside of the closed position notch 42. The detent 22 travels along rail 38, 40 as the cassette 32 continues to be extended from chassis 50. When cassette 32 is extended far enough such that access position notch 44 reaches detent 22, the resilient aspect of the latch 12 causes the detent 22 to locate in access position notch 44 stopping cassette 50 from being extended any further.

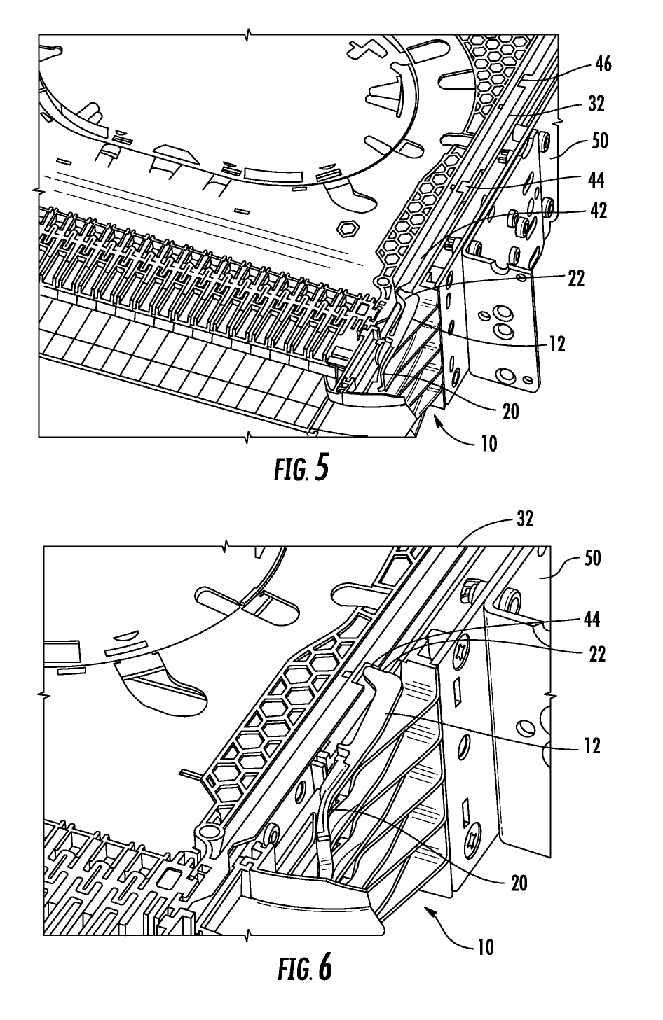

FIG. 6 shows detent 22 in access position notch 44. Since access position notch 44 has straight sides, the cassette 50 cannot be extended further from or moved back into chassis 50 without first operating finger actuator 20 to pivot latch 12 and move detent 22 out of access position notch 44. Once the finger actuator 20 is operated pivoting latch 12 and moving detent 22 out of access position notch 44, the cassette may be extended further until the remove position notch 46 reaches detent 22 and due to the resilient aspect of the latch 12, detent 22 locates in remove position notch 46 stopping the travel of cassette 32. To remove cassette 32 from chassis 50, finger actuator 20 may be operated to move detent 22 out of remove position notch 46 and cassette 32 may be removed from chassis 50. Alternatively, cassette 32 may be moved back into chassis 50 until closed position notch 42 reaches detent 22 and detent 22 locates in closed position notch 42.

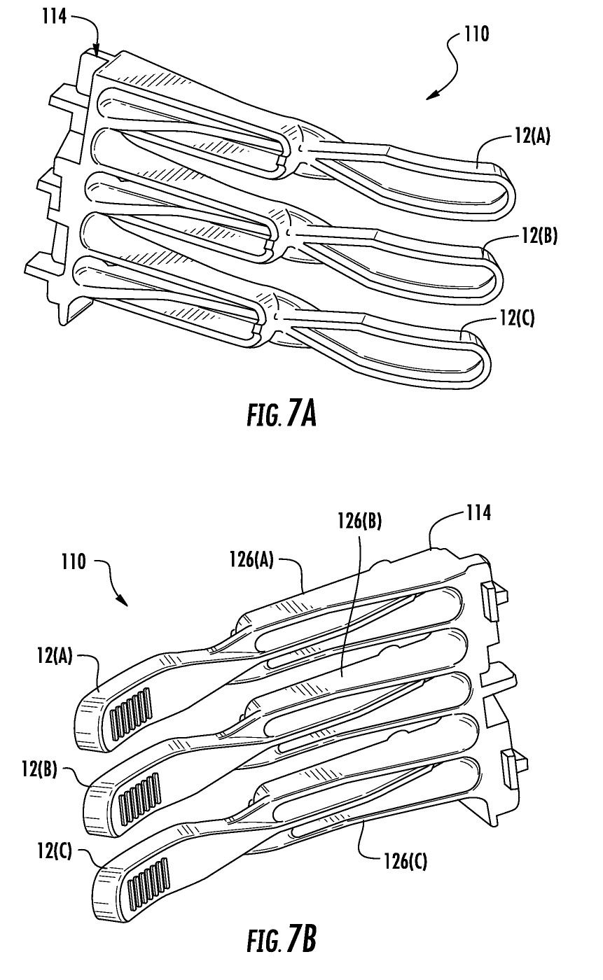

FIGS. 7A and 7B shown an outward side and an inward side, respectively, of latching assembly 110. The features of latching assembly 110 that are the same as latching assembly 10 will not be discussed again as the discussion of those features with respect to latching assembly 10 apply to latching assembly 110. In a similar manner to latching assembly 10, latching assembly 110 has latching assembly 10 has multiple independently actuatable latches 12 pivotly attached to frame 114. Instead of one support member 26 pivotly attached to each latch 12 as in latch assembly 10, latch assembly 110 has a U-shaped bracket 126 pivotly attached to latch 12. frame 114. Although in FIGS. 7A and 7B three latches 12A, 12B, 12C each having a U-shaped bracket 126A, 126B, 126B, respectively, pivotly attached, any number of latches 12 may be used, and, latch 12 may not each have a U-shaped bracket 126 pivotly attached. Latch 12 operates in the same manner as described above with respect to latch assembly 10.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A latching assembly, comprising:
a frame;
a plurality of latches pivotably attached to the frame;
an attachment feature adapted to toollessly and removably attaching the latching assembly to at least one of a housing and a chassis,
wherein each of the plurality of latches is independently actuatable to pivot and configured to selectively lock or unlock a corresponding cassette in the chassis.

2. The latching assembly of claim 1, wherein the attachment feature is integral to the latching assembly.

3. The latching assembly of claim 2, wherein the attachment feature is manufactured from the same material as the latching assembly.

4. A fiber optic equipment, comprising
a chassis configured for mounting within a network equipment rack;
a plurality of cassettes slidably coupled to the chassis and configured to slide between a forward position and a rearward position within the chassis; and
a latching assembly toollessly and removably coupled to the chassis via an attachment feature at least partially intregated with the latching assembly, the latching assembly comprising:
a frame; and
a plurality of latches pivotably attached to the frame, wherein each of the plurality of latches is independently actuatable to pivot and configured to selectively lock or unlock a corresponding cassette in the chassis.

5. The latching assembly of claim 4, wherein the attachment feature is integral to the latching assembly.

6. The latching assembly of claim 5, wherein the attachment feature is manufactured from the same material as the latching assembly.
